(19) United States
(12) Patent Application Publication
(10) Pub. No.: US 2004/0227277 A1
(43) Pub. Date: Nov. 18, 2004

(54) Method and apparatus for making a non-woven fabric

(76) Inventor: Yao-Chang Lin, Taichung City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/624,375

(22) Filed: Jul. 21, 2003

(30) Foreign Application Priority Data
May 14, 2003 (TW) 92113107

(51) Int. Cl. B29C 47/60

(52) U.S. Cl. 264/518; 264/211.22; 425/72.2

(57) ABSTRACT

A method of producing a non-woven fabric includes the steps of forming fiber strands from a fiber forming resin through a spinneret, drawing the fiber strands from the spinneret by using a drawing air jet device, forming the fiber strands on a conveyor screen belt and advancing the same along a longitudinal direction, and using a swinging air jet device to swing the fiber strands to-and-fro downstream of the drawing air jet device, upstream of the conveyor screen belt and in transverse directions which are transverse to the longitudinal direction. The fiber strands are formed into wavy patterns which overlap and interlace each other in the transverse directions.

### BACKGROUND OF THE INVENTION

1. Field of the Invention

The invention relates to a non-woven fabric, more particularly to a method and apparatus for the production of a non-woven fabric.

2. Description of the Related Art

Referring to FIG. 1, a typical non-woven fabric 1 generally has fiber strands 11 which extend longitudinally such that it has insufficient bonding force along a transverse direction. Although the non-woven fabric 1 can endure longitudinal pulling forces and possesses high longitudinal tensile strength, it is liable to break or tear when subjected to transverse pulling forces.

Referring to FIG. 2, in order to alleviate such a problem, the prior art has suggested an apparatus and a method, in which an air jet 32 is disposed close to fiber strands 31 which are extruded from a spinneret 2 to flow at a rate which is greater than the rate of extruding the fiber strands 31. The air jet 32 causes the fiber strands 31 to swing randomly so that the fiber strands 31 are bent and interlace each other, thereby increasing the bonding force between fiber strands 31. However, although the flow rate of the air jet 32 must be greater than that of the fiber strands 31 so as to bend or turn the same, the flow rate must not be very high. Otherwise, the linear air jet 32 will provide a drawing force to pull the fiber strands 31 downward, adversely affecting the turning or bending of the fiber strands 31. In addition, since the extruding rate of the fiber strands 31 varies depending on the material thereof, it is difficult to precisely control the rates of the air jet 32 and the fiber strands 31.

### SUMMARY OF THE INVENTION

Therefore, the object of the present invention is to provide an apparatus and a method for making a non-woven fabric which has an increased tensile strength along a transverse direction.

According to one aspect of this invention, a method of producing a non-woven fabric comprises the steps of forming fiber strands from a fiber forming resin through a spinneret, drawing the fiber strands from the spinneret by using a drawing air jet device, forming the fiber strands on a conveyor screen belt and advancing the same along a longitudinal direction, and using a swinging air jet device to swing the fiber strands to-and-fro downstream of the drawing air jet device, upstream of the conveyor screen belt and in transverse directions which are transverse to the longitudinal direction. The fiber strands are formed into wavy patterns, which overlap and interlace each other in the transverse directions.

According to another aspect of this invention, an apparatus for making a non-woven fabric comprises a spinneret for forming fiber strands, a drawing air jet device disposed downward of the spinneret for drawing the fiber strands downwardly, a conveyor screen belt disposed downstream of the drawing air jet device for forming and advancing the fiber strands in a longitudinal direction, and a swinging air jet device disposed downstream of the drawing air jet device and upstream of the conveyor screen belt for swinging the fiber strands to-and-fro in transverse directions which are transverse to the longitudinal direction. The fiber strands are formed into wavy patterns which overlap and interlace each other in the transverse directions.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a typical non-woven fabric;

FIG. 2 is a perspective view to illustrate a conventional method for making a non-woven fabric;

FIG. 3 is a fragmentary perspective view of an apparatus for making a non-woven fabric according to the present invention;

FIG. 4 is a fragmentary schematic view of the apparatus of the present invention;

FIG. 5 is a schematic side view of the apparatus of the present invention, illustrating the directions of air currents generated thereby;

FIG. 6 is a perspective view of a swinging air jet device of the apparatus of the present invention;

FIGS. 7 and 8 illustrate how a motor drives swinging louvers to swing to-and-fro transversely;

FIG. 9 is a schematic view, illustrating fiber strands formed into wavy patterns which overlap and interlace each other through the apparatus of the present invention; and

FIG. 10 is a schematic view, illustrating an alternative implementation of the apparatus of the present invention.

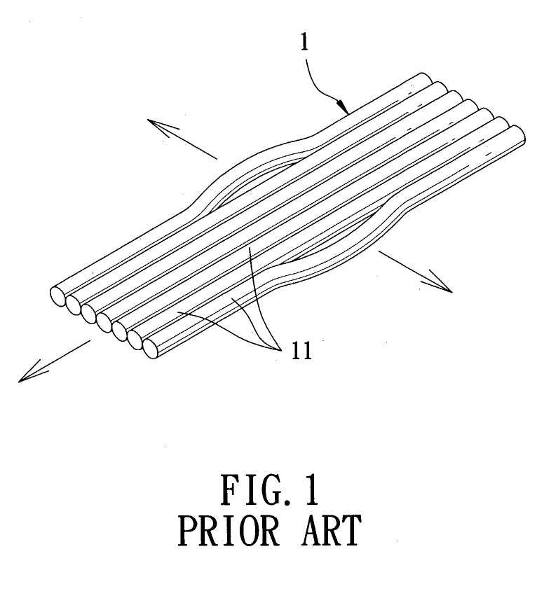

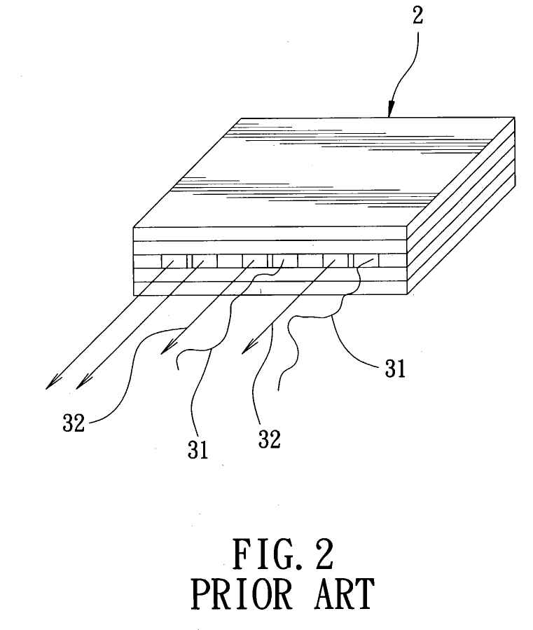

### DETAILED DESCRIPTION OF THE PREFERRED EMBODIMENT

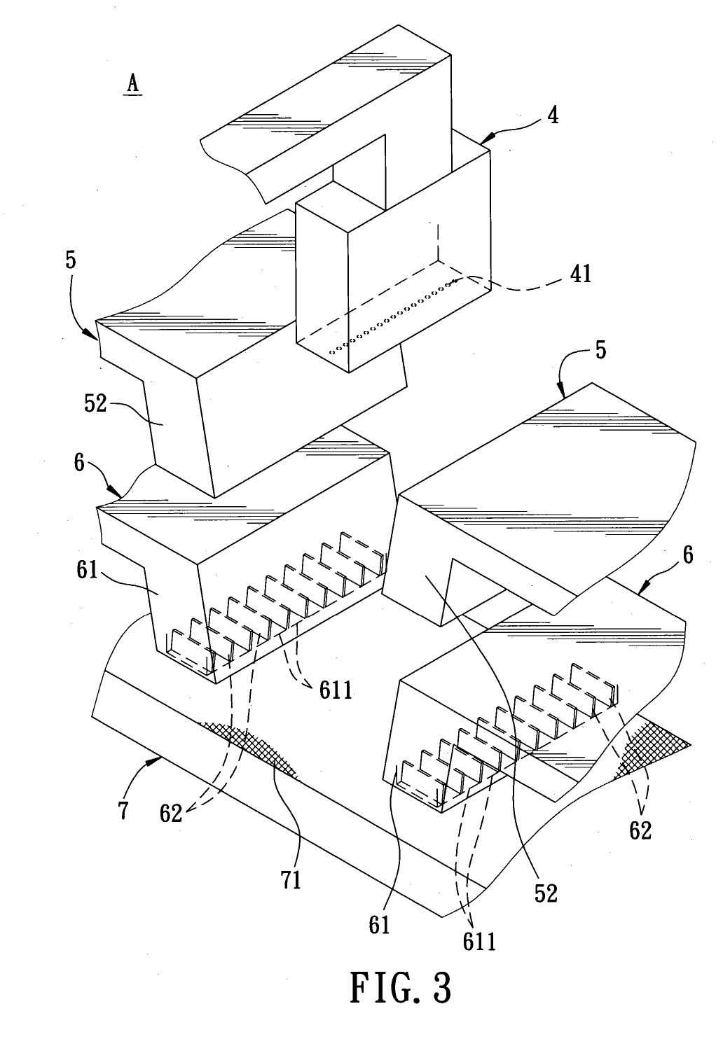

Referring to FIGS. 3, 4 and 5, a method of producing a non-woven fabric embodying the present invention is conducted through an apparatus (A) which is shown to comprise a spinneret 4, a drawing air jet device 5, a swinging air jet device 6, and a conveyor screen belt 7.

The spinneret 4 has a plurality of extrusion holes 41 which extend vertically for forming and extruding fiber strands 81.

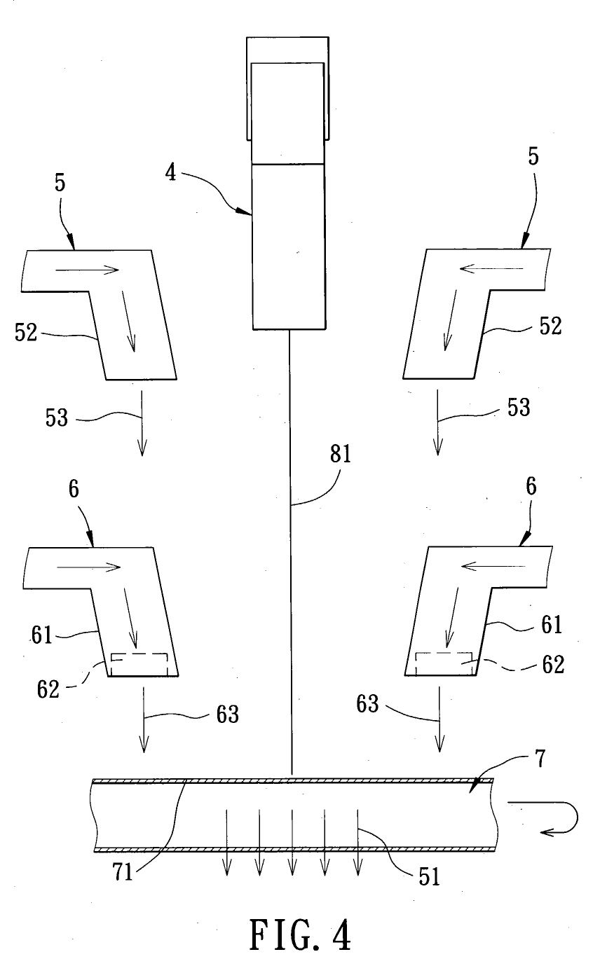

The drawing air jet device 5 is disposed downstream of the spinneret 4, and produces high pressure air currents 53 (see FIG. 4) which flow downwardly below and at two sides of the spinneret 4 through opposite air nozzle units 52 so as to draw the fiber strands 81 downwardly.

The swinging air jet device 6 is disposed downstream of the drawing air jet device 5 and upstream of the conveyor screen belt 7, and includes a pair of opposite air nozzle units 61, which are respectively arranged below the air nozzle units 52 of the drawing air jet device 5 and each of which includes a nozzle outlet 611 that opens downwardly. A plurality of swinging louvers 62 are disposed at the nozzle outlet 611 of each nozzle unit 61.

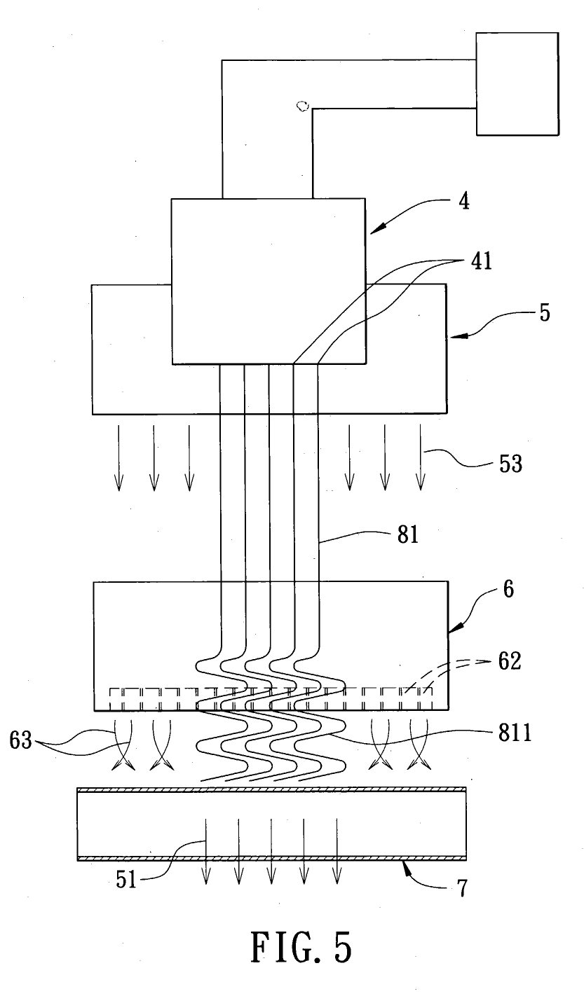

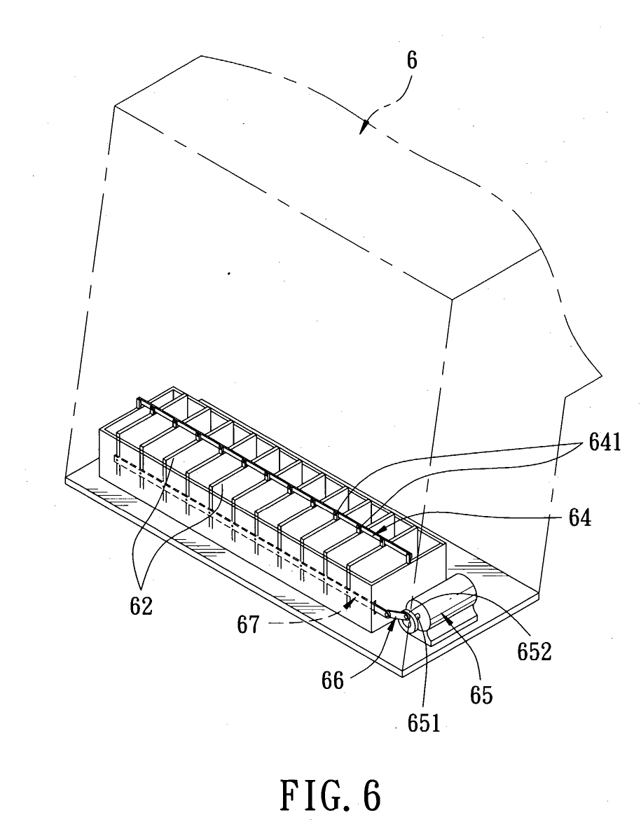

As shown in FIGS. 6, 7 and 8, the swinging louvers 62 are arranged in a row along a direction transverse to the longitudinal direction of the conveyor screen belt 7, and are mounted pivotally on a connecting bar 64 through pivot pins 641. A motor 65 is provided to drive the louvers 62 to swing transversely so as to produce swinging air currents 63 (see FIG. 5). The motor 65 includes a driving shaft 651 and a rotary disc 652 connected to the driving shaft 651. A link plate 66 has one end connected pivotally to the rotary disc 652 through a pivot member 661, and another end connected to a drive bar 67 through another pivot member 662. The drive bar 67 is connected pivotally to all of the louvers 62.

The conveyor screen belt 7 is disposed downstream of the drawing and swinging air jet devices 5, 6 for forming and advancing the fiber strands 81 in a longitudinal direction. Suction air currents 51 are provided below the conveyor screen belt 7. The conveyor screen belt 7 has a support face 71 facing toward the spinneret 4 and extending horizontally.

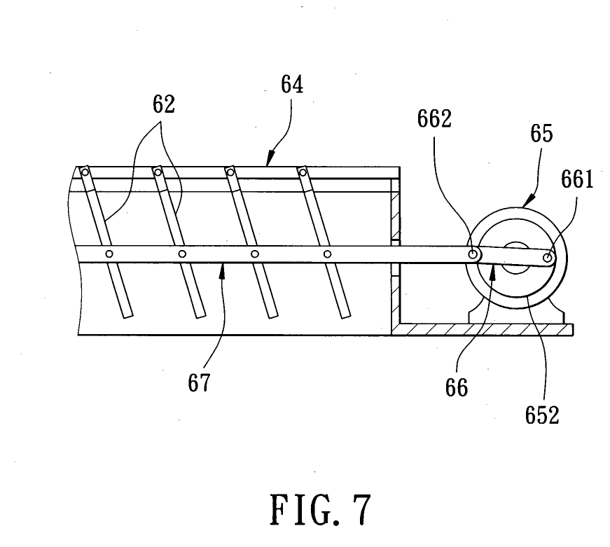

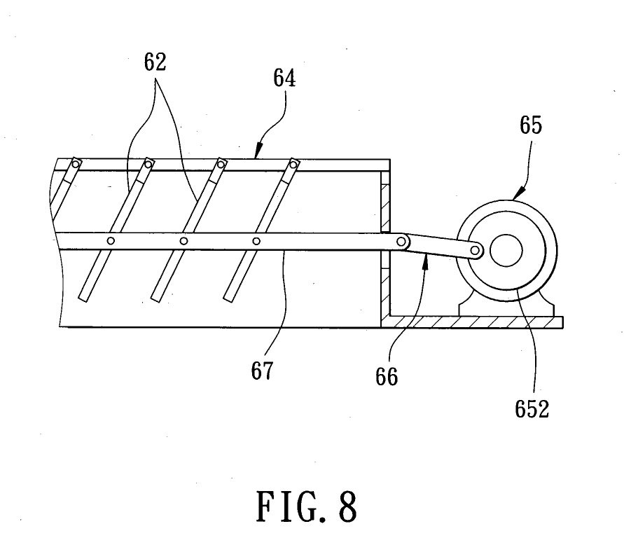

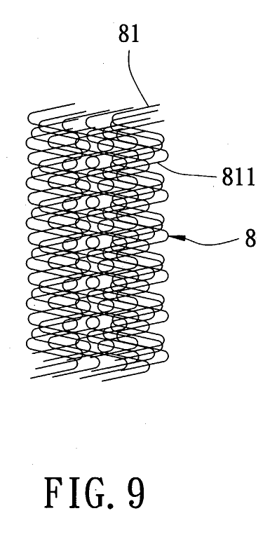

When the motor 65 of the swinging air jet device 6 is actuated, the rotary disc 652 moves the louvers 62 to-and-fro through the link plate 66, as shown in FIGS. 7 and 8. The louvers 62, in turn, produce swinging air currents 63, as shown in FIG. 5. The swinging air currents 63 cause the fiber strands 81 to swing to-and-fro in transverse directions, which are transverse to the longitudinal direction of the conveyor screen belt 7, so that the fiber strands 81 are formed into wavy patterns 811 which overlap and interlace each other, as shown in FIG. 9.

Referring again to FIG. 5, in the method according to the present invention, a plurality of fiber strands 81 are produced from a fiber forming resin through the spinneret 4. In this embodiment, the fiber strands 81 are unidirectional, and are formed by melting a fiber forming resin, such as polypropylene or polyethylene, and by extruding the same vertically through the extrusion holes 41 in the spinneret 4. Since the drawing air jet device 5 produces downward air currents 53, the fiber strands 81 are then drawn downwardly from the spinneret 4 by the air currents 53 immediately after exiting the extrusion holes 41. Afterwards, the downwardly moving fiber strands 81 are blown by the swinging air currents 63 produced by the swinging air jet device 6 so that the fiber strands 81 are swung to-and-fro downstream of the drawing air jet device 5, upstream of the conveyor screen belt 7, and in transverse directions so as to form wavy patterns 811 which overlap and interlace each other in the transverse directions.

Finally, the downward fiber strands 81 are formed on the support face 71 of the conveyor screen belt 7, and are advanced longitudinally by the conveyor screen belt 7. As shown in FIG. 6, the wavy patterns 811 of the fiber strands 81 are entangled with each other and are superimposed one upon another, thereby forming a non-woven fabric 8, which is not only resistant to longitudinal pulling forces, but also has high transverse bonding strength.

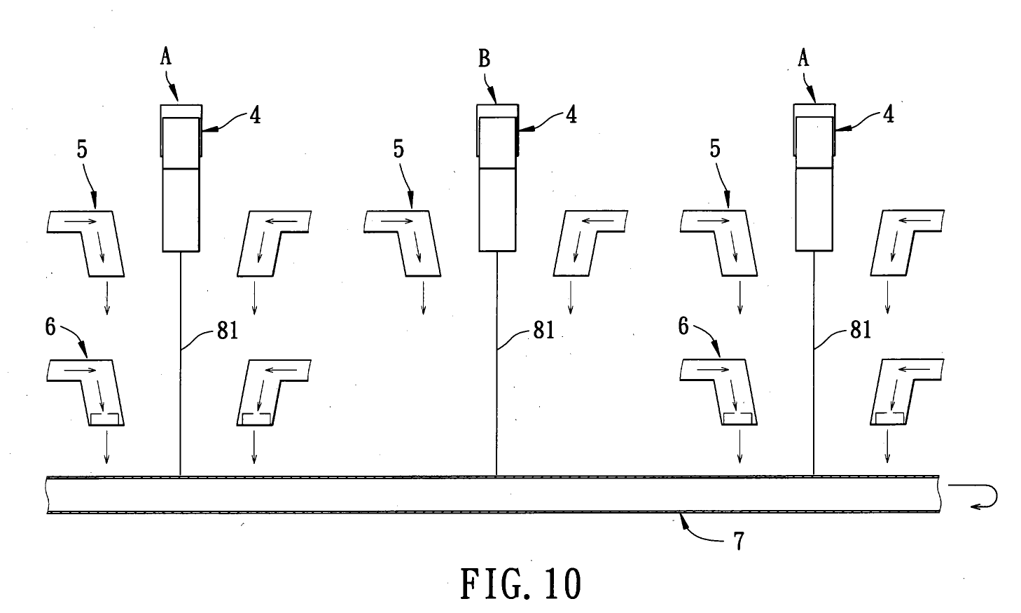

Referring to FIG. 10, a plurality of the apparatuses, specifically, two apparatuses (A) and one apparatus (B) are arranged side by side above a common conveyor screen belt 7 to fabricate a non-woven fabric (not shown). The apparatus (B) differs from the apparatus (A) in that the apparatus (B) is not provided with the swinging air jet device 6. The non-woven fabric as produced includes three fiber layers which are superimposed one above the other.

As described above, in the present invention, through rolling method, the fibers strands 91 the swinging air currents 63 produced by the swinging air jet device 6 blow the downward fiber strands 81 so that the fiber strands 81 can form wavy patterns 811, which overlap and interlace each other, thereby increasing the transverse bonding strength of the non-woven fabric 8. As such, through the method and apparatus of the present invention, a non-woven fabric 8 with high longitudinal and transverse tensile strengths can be obtained. Precise control of the rates of the air currents and the fiber strands 81 is not needed in the present invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A method of producing a non-woven fabric, comprising:
(a) forming fiber strands from a fiber forming resin through a spinneret;
(b) drawing the fiber strands from the spinneret by using a drawing air jet device;
(c) forming the fiber strands on a conveyor screen belt and advancing the same along a longitudinal direction; and
(d) using a swinging air jet device to swing the fiber strands to-and-fro downstream of the drawing air jet device, upstream of the conveyor screen belt and in transverse directions which are transverse to the longitudinal direction, wherein the fiber strands are formed into wavy patterns which overlap and interlace each other in the transverse directions.

2. The method as claimed in claim 1, wherein the swinging air jet device is used to produce swinging air currents in step (d) to blow the fiber strands, the swinging air jet device having a plurality of swinging louvers.

3. An apparatus for making a non-woven fabric, comprising:
a spinneret for forming fiber strands;
a drawing air jet device disposed downstream of said spinneret for drawing the fiber strands;
a conveyor screen belt disposed downstream of the drawing air jet device for, forming and advancing the fiber strands in a longitudinal direction; and
a swinging air jet device disposed downstream of the drawing air jet device and upstream of the conveyor screen belt for swinging the fiber strands to-and-fro in transverse directions which are transverse to the longitudinal direction, wherein the fiber strands are formed into wavy patterns which overlap and interlace each other in the transverse directions.

4. The apparatus as claimed in claim 3, wherein the swinging air jet device includes a plurality of swinging louvers to produce swinging air currents.

5. The apparatus as claimed in claim 3, wherein the swinging air jet device includes a nozzle outlet, and a plurality of swinging louvers disposed at said nozzle outlet, said swinging louvers being arranged in a row along a direction transverse to the longitudinal direction.
